(19) United States
(12) Patent Application Publication
(10) Pub. No.: US 2015/0052208 A1
(43) Pub. Date: Feb. 19, 2015

(54) INVOCATION OF SEQUENCED APPLICATIONS BASED ON DYNAMIC PARAMETERS

(71) Applicant: Avaya Inc., Basking Ridge, NJ (US)

(72) Inventors: Harsh V. Mendiratta, East Brunswick, NJ (US); Gordon R. Brunson, Broomfield, CO (US); Rajeshwari Edamadaka, Allentown, NJ (US)

(73) Assignee: Avaya Inc., Basking Ridge, NJ (US)

(21) Appl. No.: 14/043,334

(22) Filed: Oct. 1, 2013

Related U.S. Application Data
(60) Provisional application No. 61/865,949, filed on Aug. 14, 2013.

(51) Int. Cl. H04L 12/58

(52) U.S. Cl. CPC H04L 51/18
USPC 709/206

(57) ABSTRACT

Systems and methods are described for selecting applications for incorporation into an application sequence. The selected applications provide one or more features to a communication session and the order of applications selected for the application sequence depends, at least in part, on one or more dynamic parameters. The consideration of dynamic parameters for application sequencing provides a more flexible alternative to traditional application sequencing based on static parameters, like user identities.

### FIELD OF THE DISCLOSURE

The present disclosure is generally directed toward communications and more specifically toward Session Initiation Protocol communications.

### BACKGROUND

Session Initiation Protocol (“SIP”) is an open signaling protocol for establishing many kinds of real-time communication sessions. Examples of the types of communication sessions that may be established using SIP include voice, video, chat, and/or instant messaging. These communication sessions may be carried out on any type of communication device such as a personal computer, laptop computer, Personal Digital Assistant, telephone, mobile phone, cellular phone, smartphone, or the like. One key feature of SIP is its ability to use an end-user's Address of Record (AoR) as a single unifying public address for all communications. Thus, in a world of SIP-enhanced communications, a user's AOR becomes their single address that links the user to all of the communication devices associated with the user. Using this AOR, a contactor can reach any one of the user's communication devices without having to know each of the unique device addresses or phone numbers.

Many SIP communications are enhanced by virtue of the fact that an application or feature is inserted or included into the communication session during the establishment of that session. The incorporation of applications into a communication session is typically referred to as application sequencing because the applications are sequentially invoked during the establishment of the communication session. In some instances the applications are owned and operated by an enterprise that is administering the SIP network. In some instances, the applications may be provided by third-party vendors. In either event, the traditional way in which applications are included in the communication session is during the communication session establishment stage so that these applications can insert themselves into the signaling and media path of the communication session.

Exemplary types of applications that may be utilized for a communication session include, without limitation, call recording applications, communication log services, conferencing applications, security applications, encryption applications, collaboration applications, whiteboard applications, mobility applications, presence applications, media applications, messaging applications, bridging applications, and any other type of application that can supplement or enhance communications.

Sequencing calls and other SIP-based sessions through a pre-determined set of applications based on the desired features provisioned for a user is a powerful concept used in IP-Multimedia Subsystem (IMS) networks and by providers of enterprise communication solutions, such as Avaya. Application sequencing allows a given sequenced application to focus on the logic of its own feature independently of which user is being offered the feature or which other features might also be offered by other sequenced applications, before or after in the sequence. Unfortunately, the currently-available application sequencing solutions are not very flexible, thereby limiting their utility.

### SUMMARY

It is with respect to the above issues and other problems that the embodiments presented herein were contemplated. In particular, embodiments of the present disclosure recognize that in some situations it would be advantageous to select a particular next application in an application sequence based on inspection of dynamic parameters at the moment a communication session is being established, rather than on the static pre-provisioned order of applications assigned to the users in the call. Non-limiting examples of the dynamic parameters that may be analyzed to influence application sequencing include the following: region of the world from which a call originates; amount or type of bandwidth being requested in a particular network region; precedence level of the call (or other in-progress calls); affinity of servers already sequenced in the call; whether the call is originating from or directed to a mobile device; processing capabilities of the phone and/or servers; whether the call is an emergency call; current time information; whether or not the call is associated with, directed toward, or originating from a call center; context information; and combinations thereof.

Embodiments of the present disclosure enable the automated determination of certain sequenced applications based on dynamic properties of the call set-up request. In particular, embodiments of the present disclosure provide the flexibility to invoke applications based on information other than user ID if a different parameter is more important than a user ID.

While certain examples of the present disclosure will be directed toward “calls” and “call set-up”, it should be appreciated that embodiments of the present disclosure are not so limited. In particular, the concepts disclosed herein can be utilized for application sequencing in connection with any type of contact, whether real-time (e.g., voice calls, video calls, teleconferences, webconferences, etc.), near-real-time (e.g., chats, Instant Messaging (IM) sessions, Short Message Service (SMS) sessions, etc.), or non-real-time (e.g., email, social media conversations and postings, etc.). Furthermore, embodiments of the present disclosure can also be applied to application sequencing in connection with processing tasks other than establishing communication sessions.

With respect to SIP-based communication sessions, a sequenced application is one of a series of applications that may be invoked in a specific order by a communication server during call set-up or termination to add features to calls. Application sequences are typically defined by user ID for origination (calling party) and termination (called party) sides of calls. When a call is initiated, the caller's authoritative session manager may route a session initiation request through each application in the caller's origination sequence, then the called party's authoritative session manager (which may or may not be the same as the caller's) routes the request through each application in the called party's termination sequence, before finally delivering the call to a called device. For example, a sequenced application might include an application that uses a person's presence (active, away, on-the-phone, on vacation, etc.) to route an incoming call to the appropriate service, an application that identifies and blocks malicious calls, and an application that invokes a call recorder. In traditional systems, the rules that apply to a person are invoked no matter how that person initiates a communication.

Embodiments of the present disclosure expand on the rigid application-sequencing policies by invoking applications based on parameters other than user ID, such as location, bandwidth, emergency, time-based, critical/non-critical, combinations thereof, other dynamic/variable parameters, etc. This provides the flexibility to trigger applications using a variety of parameters (e.g., if someone is sitting in a particular location, then a set of applications should be invoked based on that user's currently location information).

Non-limiting examples of parameters for invoking sequenced applications may include:
Location
Importance of call
Mobile Device
Bandwidth
Processing Availabilities
Emergency call
Time Information
Call Center Call (or not)
Context Information

An example of when this might be useful would be with Multiple Level (or Multi-Level) Precedence and Preemption (MLPP). MLPP, as a military application, allows a high ranking official to break into or preempt a call (knock down) in the case of an emergency. By utilizing embodiments of the present disclosure, applications are moved or initiated/invoked based on logic and information describing where the call is made, or possibly with other information that identifies the call as a high preference call.

In accordance with at least some embodiments of the present disclosure, a method is provided which generally comprises:

receiving a first message in connection with a communication session between a first user and at least a second user;

analyzing a dynamic parameter that is at least one of referenced in and associated with the first message; and

based on the analysis of the dynamic parameter, determining an application sequence for the communication session.

In some embodiments, a dynamic parameter may correspond to any time-variable value or collection of values. A dynamic parameter may, therefore, correspond to a single parameter or a set of parameters, which may or may not be related. In particular, a dynamic parameter may include any variable other than an identifier of a user associated with a communication session (e.g., as a participant, caller, callee, conferencor, conferencee, transferee, transferor, etc.). A dynamic parameter may be variable based on the passage of time, based on the occurrence of events, and/or based on re-administration of a variable by a user or administrator.

A dynamic parameter may be reference in and/or associated with a message (e.g., a SIP message) by being defined as a parameter within a header, body, or trailer of the message, by having a link (e.g., Universal Resource Locator (URL), Universal Resource Indicator (URI), etc.) described within a portion of the message, or having instructions for retrieving the parameter described in the message (e.g., request dynamic parameter A from server B, perform database query “ABC” with database Z, etc.). Thus, a dynamic parameter may have its value defined within a message or the message may have a description of the value's location or instructions for retrieving the value. Said another way, a dynamic parameter may be self-contained within the message itself or it may be external to the message and, therefore, requires additional processing to determine.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “address of record” or “address or record URI” (“AoR”) refers to a URI that corresponds to a user. Unlike a contact URI (or device URI), a request sent to an AoR requires database lookups and service and feature operations and can result the request being sent to one or more end (communication) devices. An AoR is usually used in T0 and FROM header fields. This is a common way to reach a person and is suitable for storing in address books and in returning missed calls.

The term “computer-readable medium” as used herein refers to any tangible storage and/or transmission medium that participates in storing and/or providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, RAM, PROM, EPROM, FLASH-EPROM, solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

The term “contact URI” refers to a device Universal Resource Indicator (“URI”). A device URI is typically in a CONTACT header field and is associated with a particular user for a period of time. An address of record URI can be related or bound to a contact URI.

The terms “determine,” “calculate” and “compute,” and variations thereof, as used herein, are used interchangeably and include any type of methodology, process, mathematical operation or technique.

The term “module”, “agent”, or “tool” as used herein refers to any known or later developed hardware, software, firmware, artificial intelligence, fuzzy logic, or combination of hardware and software that is capable of performing the functionality associated with that element. Also, while the disclosure is described in terms of exemplary embodiments, it should be appreciated that individual aspects of the disclosure can be separately claimed.

The term “uniform resource identifier” (URI) is a string of characters used to identify a name or a resource.

The term “uniform resource locator” or “universal resource locator” (URL) is a specific character string that constitutes a reference to an Internet resource.

A “user agent” refers to a Session Initiation Protocol (“SIP”)-enabled endpoint device. The user agent takes direction and/or input from a user and acts as an agent on behalf of the user to set up and tear down media sessions.

The preceding is a simplified summary of embodiments of the disclosure to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below.

### BRIEF DESCRIPTION OF THE DRAWINGS

The present disclosure is described in conjunction with the appended figures:

FIG. 1 is a block diagram of a communication system in accordance with embodiments of the present disclosure;

FIG. 2 is a flow diagram of a first communication method in accordance with embodiments of the present disclosure;

FIG. 3 is a flow diagram of a second communication method in accordance with embodiments of the present disclosure; and

FIG. 4 is a block diagram depicting a data structure used in accordance with embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the embodiments. It being understood that various changes may be made in the function and arrangement of elements without departing from the spirit and scope of the appended claims.

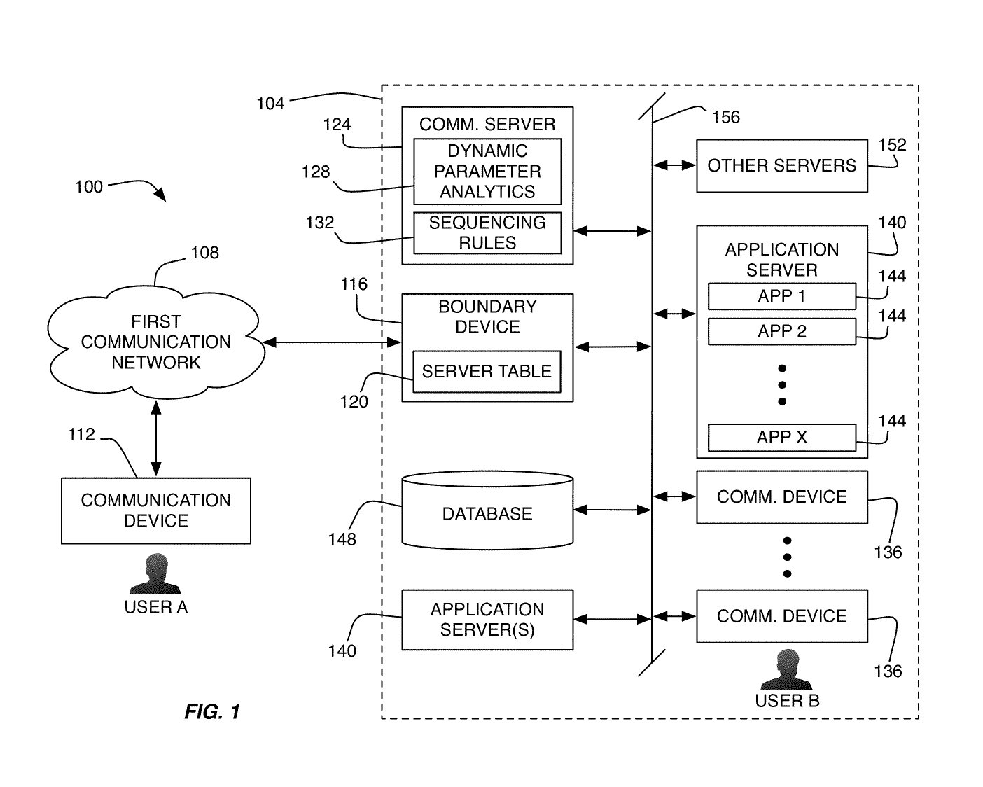

FIG. 1 depicts a communication system 100 according to an embodiment of the present disclosure. The communication system 100 may include an enterprise network 104 that is in communication, via a (typically untrusted or unsecure or public) communication network 108, with one or more external communication devices 112.

The communication network 108 may be packet-switched and/or circuit-switched. An illustrative communication network 108 includes, without limitation, a Wide Area Network (WAN), such as the Internet, a Public Switched Telephone Network (PSTN), a Plain Old Telephone Service (POTS) network, a cellular communications network, a Voice over IP (VoIP) network, an IMS network, or combinations thereof. In one configuration, the communication network 108 is a public network supporting the TCP/IP suite of protocols.

The external communication device(s) 112 is generally referred to as “external” because it is either not under the direct control of the enterprise administering the enterprise network 104 or has a decreased level of trust with the enterprise network 104 as compared with communication devices 136 that are within the enterprise network 104. Illustrative types of external communication devices 112 include, without limitation, cellular phones, laptops, Personal Computers (PCs), Personal Digital Assistants (PDAs), digital phones, analog phones, smartphones, and the like.

The enterprise network 104 may include a boundary device 116 including a server table 120, a communications server 124 including dynamic parameter analytics 128 and sequencing rules 132, one or more internal communication devices 136, one or more application servers 140 which may be capable of providing one or multiple applications 144, a number of other servers 152, and an enterprise database 148, all of which are interconnected by a (trusted or secure or private) Local Area Network (LAN) 156. Some or all of the functions depicted in FIG. 1 may be co-hosted and/or co-resident on a single server. Alternatively or additionally, some or all of the components of the enterprise network 104 may be made available via cloud computing technologies. For instance, some or all functions of the servers may be made available from a cluster of servers that may or may not necessarily be co-located with the communication devices 136. In other words, the enterprise network 104 may be partially cloud-based and access to the resources of the cloud-based network may be obtained through the communication network 108. The depiction of components in FIG. 1 is generally intended to be a logical depiction of the components of the system 100.

In some embodiments, network boundary device 116 is responsible for initially routing communications within the enterprise network 104 to the communications server 124 responsible for servicing a particular user (e.g., User A and/or User B) involved in the communication session. For example, if an enterprise user (e.g., User B) is being called by an external communication device 112, then the network boundary device 116 may initially receive the inbound call, determine that the call is directed toward User B, reference the server table 120 to identify the authoritative communications server 124 for User B, and route the inbound call to the authoritative communications server 124. Likewise, communications between internal enterprise users (e.g., internal communication devices 136) may first be serviced by the originating user's authoritative communications server 124 during the origination phase of communications set-up. After the origination phase is complete, the authoritative communications server 124 of the terminating (or called) user may be invoked to complete the termination phase of communications set-up. In some embodiments, the communications server 124 for the originating and terminating user may be the same, but this is not necessarily required. In situations where more than two enterprise users are involved in a communication session, authoritative communications servers 124 for each of the involved users may be employed without departing from the scope of the present invention. Additionally, the authoritative communications servers 124 for each user may be in the same enterprise network 104 or in different enterprise networks 104, which are owned by a common enterprise but are separated by the communication network 108.

In accordance with at least some embodiments of the present invention, the mapping of user identities within a communication request does not necessarily have to occur at the network boundary device 116. For instance, the mapping between an authoritative server and a user may occur “behind” the network boundary device 116 within the enterprise network 104.

The communications server 124 can include a Private Branch eXchange (PBX), an enterprise switch, an enterprise server, combinations thereof, or other type of telecommunications system switch or server. The communications server 124 is preferably configured to execute telecommunication functions such as the suite of or Avaya Aura™ applications of Avaya, Inc., including Communication Manager™, Avaya Aura Communication Manager™, Avaya IP Office™, Communication Manager Branch™, Session Manager™, System Manager™, MultiVantage Express™, and combinations thereof.

Although only a single communications server 124 is depicted in FIG. 1, two or more communications servers 124 may be provided in a single enterprise network 104 or across multiple separate LANs 156 owned and operated by a single enterprise, but separated by a communication network 108. In configurations where an enterprise or an enterprise network 104 includes two or more communications servers 124, each server 124 may comprise similar functionality, but may be provisioned for providing its features to only a subset of all enterprise users. In particular, a first communications server 124 may be authoritative for and service a first subset of enterprise users whereas a second communications server 124 may be authoritative for and service a second subset of enterprise users, where the first and second subsets of users generally do not share a common user. This is one reason why the network boundary device 116 may be provided with a server table 120.

Additionally, multiple servers 124 can support a common user community. For example, in geo-redundant and other applications where users aren't necessarily bound to a single application server, there may be a cluster of equivalent servers where a user can be serviced by any server in the cluster.

Each communications server 124 may include dynamic parameter analytics 128 as well as sequencing rules 132 to determine an application sequence or next application 144 in an application sequence based on inputs received from the dynamic parameter analytics 128. In particular, the sequencing rules 132 may define one or more dynamic parameters to be analyzed by the dynamic parameter analytics 128 when a message of a particular type is received. The received message may correspond to one originating from a user for whom the communication server 124 is authoritative or a message directed toward a user for whom the communication server 124 is authoritative. Furthermore, the sequencing rules 132 may define whether and when one or more dynamic parameters should be analyzed in connection with adjusting or determining an application sequence. In other words, the sequencing rules 132 may define a default condition that application sequencing occurs in the traditional way—sequencing based on identities of the users involved in the communication session. The sequencing rules 132 may also define conditions, if present, that will cause the application sequence to vary away from the default application sequence, in which case the dynamic parameter analytics 128 are invoked. Thus, if certain conditions are met (e.g., the received message has certain properties, it is a certain time of day, etc.), then the sequencing rules 132 may deviate away from the default application sequence and utilize inputs from the dynamic parameter analytics 128 to determine a new and different application sequence that is more suitable to the current conditions.

In some embodiments, the sequencing rules 132 may instruct the dynamic parameter analytics 128 to analyze a received message to determine if any dynamic parameters exist within the message and further determine if the values of those dynamic parameters will impact an application sequencing decision. Additionally or alternatively, the dynamic parameter analytics 128 may receive an identification of a parameter or instructions for retrieving a parameter from a source other than the received message (e.g., database 148, other servers 152, etc.). The dynamic parameter analytics 128 may then retrieve the current value of the identified parameter(s) and return the corresponding value(s) to the sequencing rules 132, where an application sequencing decision can be made.

In some embodiments, the sequencing rules 132 may correspond to communication feature preferences for each user for which it is authoritative. The sequencing rules 132 for a particular user are referenced by the authoritative communications server 124 for the user to determine which, if any, features should be incorporated into a communication session for the user (e.g., via an application 144) and an order in which such features should be incorporated into the communication session. The communications server 124 can actually provide communication features directly into the communication session or determine an application sequence, which will be invoked during set-up and used during the communication session.

It should be appreciated that the sequencing rules 132 may be a list of preferences, may be a table containing communication preferences, or can be in any other suitable format. Furthermore, the sequencing rules 132 can be provisioned by users and/or by administrative personnel.

It is also to be understood that any data structure can be used to render the various preference tables, including, without limitation, primitive, composite, or abstract data types, linear data structures, tree data structures, hashes, graphs, and the like.

The LAN 156 can be secured from intrusion by untrusted parties by a gateway and/or firewall located between the LAN 156 and communication network 108. In some embodiments the boundary device 116 may include the functionality of the gateway and/or firewall. In some embodiments, a separate gateway or firewall may be provided between the boundary device 116 and the communication network 108.

The other servers 152 may comprise email servers, voicemail servers, calendaring servers, conferencing servers, and other types of servers known to provide particular services to client devices. In some embodiments, the other servers 152 may also be considered application servers 140, which provide one or more applications 144 for use in a communication session.

The internal communication devices 136 can be similar or identical to the external communication devices 112, except they are provisioned, and often owned, by the enterprise. Exemplary types of communication devices 112 include, without limitation, any capable phone, hardphone, softphone and/or digital telephone. Examples of suitable telephones include the 1600™, 2400™, 4600™, 5400™, 5600™, 9600™, 9620™, 9630™, 9640™, 9640G™, 9650™, and Quick Edition™ telephones, IP wireless telephones (such as Avaya Inc.'s IP DECT™ phones), video phones (such as Avaya Inc.'s Videophone™), and softphones of Avaya, Inc.

The enterprise database 148 includes enterprise subscriber information, such as name, job title, electronic address information (e.g., telephone number, email address, instant messaging handle, direct dial extension, and the like), subscriber contact lists (e.g., contact name and electronic address information), other employee records, and the like. Additionally or alternatively, the enterprise database 148 may contain presence information for a user, communication capabilities for a user, and any other dynamic variable that is retrievable by the dynamic parameter analytics 128. In some embodiments, the database 148 may comprise data in a certain structural format (e.g., hierarchical database, SQL database, etc.) or an unstructured format (e.g., No-SQL database, etc.). The database may include persistent storage (disk) or may be only an in-memory database.

In accordance with at least some embodiments, the communications server 124 determines an application sequence and causes one or more applications 144 to be sequenced into a communication session in accordance with the sequencing rules 132. In particular, the communications server 124 is configured to analyze a particular user's sequencing rules 132 and invoke the necessary applications 144 and routing to fulfill such preferences. The applications 144 invoked for a particular user at one point in time may be different from the applications 144 or order of applications 144 invoked for the same user at a different point in time, particularly if one of the application sequences is based on a current value of a dynamic parameter or multiple dynamic parameters.

Once an application sequence is determined by the communications server 124, the communications server 124 passes the communication-establishing message to a first application 144 in the application sequence, thus allowing the first application to determine the parameters of the communication session, insert itself into the control and/or media stream of the communication session, and thereby bind itself to the communication session. Once the first application has inserted itself into the communication session, the first application either passes the communication-establishing message back to the communications server 124 to identify the next application in the application sequence (e.g., based on the sequencing rules 132) or passes the communication-establishing message directly to a second application in the application sequence. Alternatively, or in addition, the message may be redirected, rejected, or the like. Moreover, parties and/or media servers may be added to the call by an application 144.

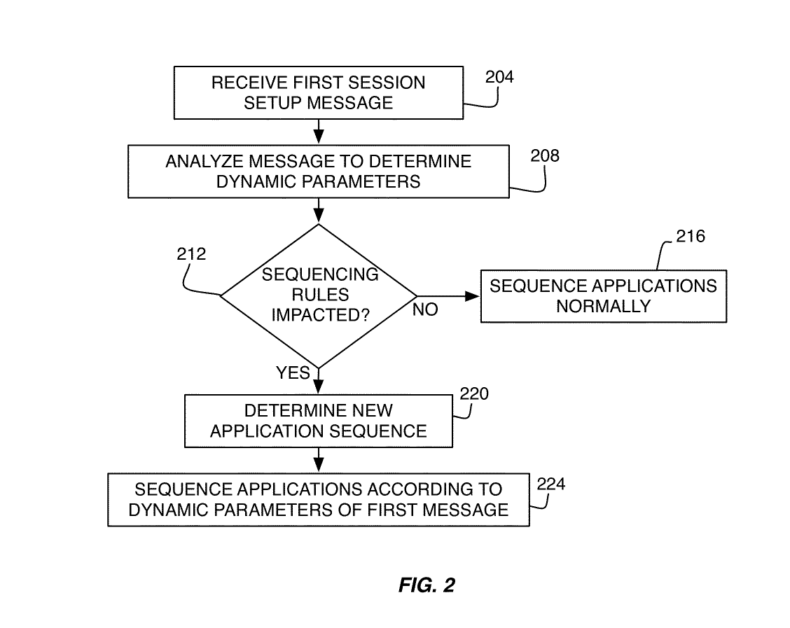

With reference now to FIG. 2, a first communication method will be described in accordance with embodiments of the present disclosure. The method begins with the communication server 124 receiving a first session setup message (step 204). In some embodiments, the first message received at the communication server 124 may correspond to a SIP message used in connection with the establishment of a SIP-based communication session (e.g., INVITE, RE-INVITE, etc.). The first message may be received during an origination-side or termination-side processing of the first message. In other words, the first message may be received at a communication server 124 of a calling user (e.g., origination-side processing) and/or at a communication server 124 of a called user (e.g., termination-side processing).

Upon receiving the first message, sequencing rules 132 are referenced to begin the process of determining an application sequence for the communication session. Specifically, the sequencing rules 132 may analyze current conditions and/or analyze the message to determine if it contains or references one or more dynamic parameters (step 208). This analysis may, alternatively, be performed by the dynamic parameter analytics 128. The dynamic parameter analytics 128 then performs an analysis of the dynamic parameters in the message (if contained therein) or finds values for one or more dynamic parameters referenced within the message.

In some embodiments, the dynamic parameter analytics 128 may analyze one or a number of different dynamic parameters, either sequentially or in parallel. Suitable examples of dynamic parameters that may be analyzed by the dynamic parameter analytics 128 include, without limitation: region of the world from which a call originates; amount or type of bandwidth being requested in a particular network region; precedence level of the call (or other in-progress calls); affinity of servers already sequenced in the call; whether the call is originating from or directed to a mobile device; processing capabilities of the phone and/or servers; whether the call is an emergency call; current time information; whether or not the call is associated with, directed toward, or originating from a call center; context information; and combinations thereof

The results of the analysis are then returned to the sequencing rules 132 to determine if the dynamic parameters will have an impact on the application sequence to be invoked by the communication server 124 (step 212). As an example, if the first message was originated by an external communication device 112 (e.g., mobile device), this information may be contained in the first message and the dynamic parameter analytics 128 may determine that a certain application sequence should be invoked. As another example, if the first message originated in a particular location and/or at a particular time of day, and this combination of parameters impacts the sequencing rules 132, then a different application sequence should be invoked for the first message. Thus, depending upon the current values of one or more dynamic parameters, a suitable application sequence is determined for the communication session that will be eventually established with the first message.

If the query of step 212 is answered negatively, then the method continues with the communication server 124 invoking an application sequence according to default conditions (e.g., based solely on an identity of the calling user and/or called user)(step 216). If, on the other hand, the sequencing rules 132 are impacted by the value(s) of the dynamic parameters, then the communication server 124 determines a new application sequence (step 220) and sequences the appropriate applications 144 to provide the appropriate features to the communication session (step 224). Steps 220 and 224 may be performed a single time and each application in the sequence may pass the first message to the next application in the sequence. Alternatively, steps 220 and 224 may be iteratively performed for each next application in the sequence. Thus, in the iterative implementation, the communication server 124 may provide the first message to a first application 144 in a sequence and then receive the first message back from the first application 144. Thereafter, the next application in the sequence may be determined after which point the first message is sent to the next application. This back-and-forth process may continue until all features have been accounted for (e.g., a full application sequence has been invoked).

Once the appropriate application sequence has been invoked, the method may continue by transmitting the first message to the destination device in accordance with the communication protocols being employed (e.g., SIP) and appropriate response(s) may be created at the destination device (e.g. 2000K, ACK, etc.). The communication session is then established and the parties involved in the communication session may be allowed to media (e.g., voice, video, text, etc.) with one another until the communication session ends.

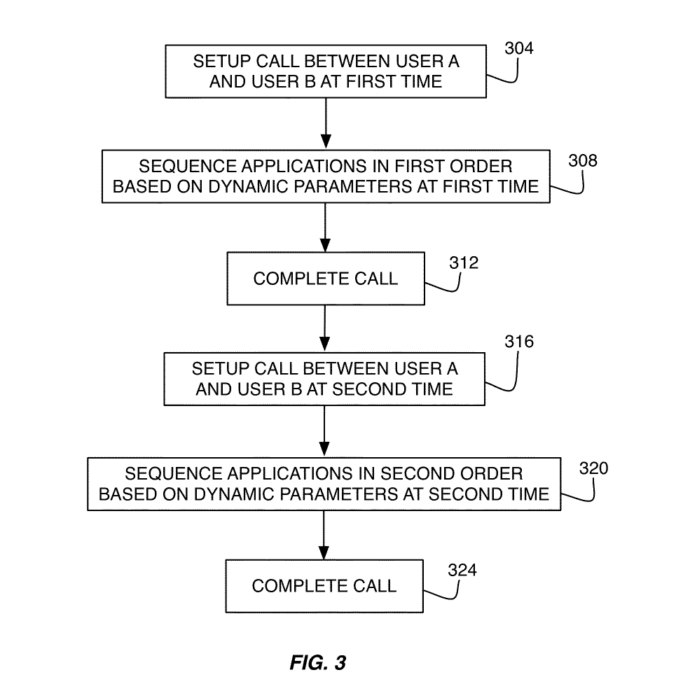

Referring now to FIG. 3, a second communication method will be described in accordance with embodiments of the present disclosure. While the following method will be described in connection with a call between two users, it should be appreciated that embodiments of the present disclosure are not so limited and the features disclosed herein can be applied to multi-party calls having three, four, five, . . . , ten, or more participants.

The method begins with the establishment of a call (or other communication session) between a first user (e.g., User A) and a second user (e.g., User B) at a first time (e.g., Time=T1) (step 304). The first call established between the users may comprise applications sequenced in a first order based on dynamic parameters determined at the first time T1 (step 308). In some embodiments, the order of applications in the application sequence may include applications for User A being in a first order and/or applications for User B being in a first order. In other words, the application sequence may comprise two halves, an origination half and a termination half, where the origination half corresponds to User A's half of the call and the termination half corresponds to User B's half of the call. In this embodiment, User A's applications may all be sequenced prior to User B's applications and the order of User A's applications may or may not depend upon the order of User B's applications.

The users are allowed to engage in the communication session for as long as is desired until eventually the session is ended and the call is completed (step 312). In this step, one or both participants may hang up and the call signaling and/or media path may be torn down, thereby allowing the resources (e.g., trunks, processors, memory, ports, etc.) previously assigned to the call to be utilized in other calls. Additionally, the servers that were providing the applications 144 to the communication session, may have their resources released for use in other communication sessions between other users. The tear down of the session may be performed in a normal fashion as is defined by SIP standards or variants thereof

The method continues at a time after the first call has been completed. Specifically, a second call may be established between User A and User B, again, but this time the call is established at a second time (e.g., Time=T2) (step 316). Even though the call is established between the same users as the previous call, one or more dynamic parameters or values thereof may have changed between time T1 and time T2. Thus, since the application sequence is at least partially determined based on the dynamic parameters, the method continues with the sequencing of applications in a second order based on the dynamic parameters determined at time T2 (step 320). The application sequence may vary only for one user (e.g., User A or User B), or the application sequence may vary for both sides of the call (e.g., both applications in the origination side and termination side may be in a different order).

As with the first call, the users are allowed to engage in the second call until it is finally completed (step 324). Again, after the second call is completed, the call may be torn down and the signaling and/or media paths may be deleted.

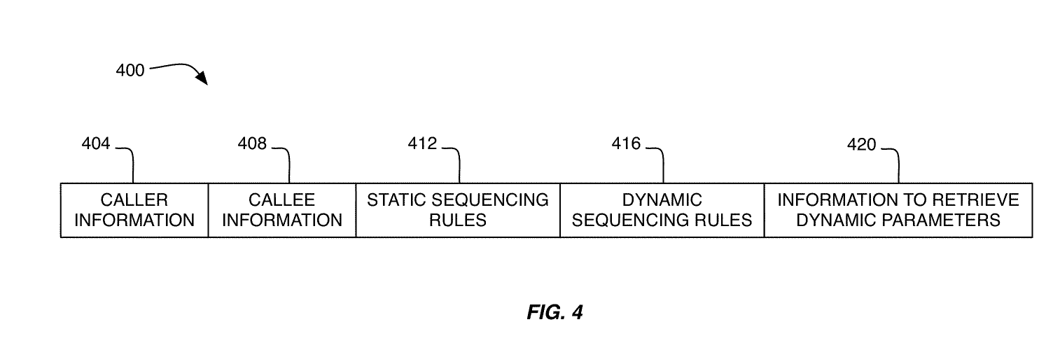

With reference now to FIG. 4, a data structure 400 that may be used to facilitate one or more of the methods described herein will be described in accordance with embodiments of the present disclosure. The data structure 400 may include a plurality of data fields including a caller information field 404, a callee information field 408, a static sequencing rules field 412, a dynamic sequencing rules field 416, and information to retrieve dynamic parameters 420. The depicted data structure 400 may be used by one, some, or all of the components described in connection with the communication system 100. For instance, the dynamic parameter analytics 128 may access part of the data structure 400 either directly from memory in the communication server 124 or from the database 148 via a query. Alternatively or additionally, the data structure 400 may include some information that exists as the sequencing rules 132 or that is available to the sequencing rules 132.

The caller information filed 404 and/or callee information field 408 may contain information that globally uniquely identifies a user or at least uniquely identifies a user within an enterprise network 104. Examples of the information that may be contained in these fields 404, 408 include, without limitation, user name, AoR, SIP alias, network address, email address, phone number, device identifiers, or combination thereof.

The static sequencing rules field 412 may contain information that is used to determine an application sequence based on non-changing parameters. As an example, the static sequencing rules field 412 may contain a user's preferred or default application sequence (or definition of features that can be provided by an application 144). These rules may be followed if no dynamic parameters are available or if no dynamic parameters impact an application sequencing decision. The static sequencing rules 412 may be provisioned by a user and/or by administrative personnel. In some embodiments, the static sequencing rules 412 may also be followed in systems that do not support the ability to look up dynamic parameters (e.g., systems without the dynamic parameter analytics 128).

The dynamic sequencing rules 416, as compared to the static sequencing rules 412, may contain events or rules that impact an application sequencing decision if one or more dynamic parameters are defined within a message, referenced within a message, or any other condition or criterion is met. The types of conditions that may be defined within the dynamic sequencing rules 416 include any dynamic parameter descried herein as well as conditions relating to that parameter. For instance, if a dynamic parameter has a certain value or meets a certain condition or set of conditions, then the dynamic sequencing rules may define a particular application sequence that is different from the sequence defined by the static sequencing rules 412. The information to retrieve dynamic parameters and their values 420 may be referenced within the dynamic sequencing rules 416 and/or may be merged therein. The information to retrieve dynamic parameters 420 may include any instructions for parsing a message to identify dynamic parameters and/or instructions for retrieving dynamic parameters from locations other than the message.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor (GPU or CPU) or logic circuits programmed with the instructions to perform the methods (FPGA). These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. A method, comprising:
receiving a first message in connection with a communication session between a first user and at least a second user;
analyzing a dynamic parameter that is at least one of referenced in and associated with the first message; and
based on the analysis of the dynamic parameter, determining an application sequence for the communication session.

2. The method of claim 1, wherein the dynamic parameter defines at least one of the following: region from which the first message originated; amount of bandwidth being requested in a particular network region; type of bandwidth being requested in a particular network region; precedence level of the communication session; affinity of servers already sequenced in the communication session; whether the communication session is originating from or directed to a mobile device; processing capabilities of at least one device involved in the communication session; whether the communication session is an emergency communication session; current time information; whether or not the communication session is associated with a call center; and context information.

3. The method of claim 1, wherein the dynamic parameter is contained within the first message.

4. The method of claim 1, wherein the dynamic parameter is referenced by the first message with at least one of a Uniform Resource Locator, Uniform Resource Identifier, and a database query.

5. The method of claim 1, wherein the dynamic parameter comprises a time variable value.

6. The method of claim 1, wherein the application sequence comprises a first application and a second application and wherein a selection of the second application occurs in response to determining that the first application is a first application in the application sequence.

7. The method of claim 1, wherein the application sequence is different from a default application sequence defined by preferences of the first user and at least a second user.

8. The method of claim 1, wherein the communication session comprises at least one of a real-time and near-real-time communication session.

9. The method of claim 1, wherein the first message comprises a SIP message.

10. The method of claim 1, wherein the application sequence comprises an origination side and a termination side and wherein a sequence of applications in at least one of the origination side and termination side are determined based on the analysis of the dynamic parameter.

11. The method of claim 1, wherein the dynamic parameter comprises a plurality of time-variable parameters.

12. A non-transitory computer readable medium having stored thereon instructions that cause a computing system to execute a method, the instructions comprising:
instructions configured to receive a first message in connection with a communication session between a first user and at least a second user; and
instructions configured to analyze a dynamic parameter that is at least one of referenced in and associated with the first message and, based on the analysis of the dynamic parameter, determine an application sequence for the communication session.

13. The computer readable medium of claim 12, wherein the dynamic parameter defines at least one of the following: region from which the first message originated; amount of bandwidth being requested in a particular network region; type of bandwidth being requested in a particular network region; precedence level of the communication session; affinity of servers already sequenced in the communication session; whether the communication session is originating from or directed to a mobile device; processing capabilities of at least one device involved in the communication session; whether the communication session is an emergency communication session; current time information; whether or not the communication session is associated with a call center; and context information.

14. The computer readable medium of claim 12, wherein the dynamic parameter is at least one of contained within a header of the first message and referenced within a header of the first message.

15. The computer readable medium of claim 14, wherein the first message comprises a SIP message.

16. The computer readable medium of claim 15, wherein the first message comprises an INVITE message.

17. The computer readable medium of claim 12, wherein the communication session comprises at least one of a real-time and near-real-time communication session.

18. A communication network, comprising:
at least one application server configured to insert one or more applications into an application sequence, thereby providing one or more features to a communication session between a first user and a second user; and
a communication server including application sequencing rules that are used to dynamically determine an order of applications to be provided in the application sequence based on one or more dynamic parameters.

19. The network of claim 18, wherein the order of applications in the application sequence vary depending upon when the communication session is established.

20. The network of claim 18, wherein the communication server determines a first order of applications in the application sequence at a first time and further determines a second order of applications in the application sequence at a second time for a second communication session that follows the communication session.
